(19) United States
(12) Patent Application Publication
(10) Pub. No.: US 2025/0108517 A1
(43) Pub. Date: Apr. 3, 2025

(54) ROBOT SYSTEM, STAGE, CONTROL METHOD, METHOD FOR MANUFACTURING PRODUCT, AND RECORDING MEDIUM

(71) Applicant: CANON KABUSHIKI KAISHA, Tokyo (JP)

(72) Inventors: TOMOHIRO HARA, Kanagawa (JP); KAZUHIKO SHINAGAWA, Tokyo (JP); TAISHI MATSUMOTO, Kanagawa (JP)

(21) Appl. No.: 18/884,338

(22) Filed: Sep. 13, 2024

(30) Foreign Application Priority Data
Sep. 28, 2023 (JP) 2023167520

(51) Int. Cl. B25J 15/00; B25J 9/00; B25J 9/16; B25J 13/08

(52) U.S. Cl. CPC B25J 15/0004; B25J 9/0096; B25J 9/1612; B25J 9/1697; B25J 13/088

(57) ABSTRACT

A robot system includes a robot capable of holding a workpiece, a plurality of support portions capable of supporting the workpiece in respective orientations different from each other, and a controller configured to control the robot. The controller is configured to be capable of executing first processing of causing the robot to hold the workpiece, and second processing of causing the robot to change a holding manner of the workpiece by using at least one support portion among the plurality of support portions.

### BACKGROUND OF THE INVENTION

### Field of the Invention

The present disclosure relates to robot technology.

### Description of the Related Art

A robot system that manufactures a product by assembling a plurality of parts that are randomly arranged is known. In automation of the robot system, there is a case where a work of changing the orientation of each of the plurality of parts that are randomly arranged to a desired consistent orientation is needed.

Japanese Patent Application Laid-Open No. 2013-212580 discloses that a robot picks up a part in a box by a hand portion, places the part in a temporary placement region in a temporary orientation, holds the part placed in the temporary region in the temporary orientation by the hand portion, and places the part at a part placement position in a finally decided orientation.

In addition, Japanese Patent Application Laid-Open No. H08-243961 discloses that a robot moves a contacted workpiece onto a temporary placement stage, images the workpiece on the temporary placement stage by a visual apparatus, thus detects the position and direction of the workpiece, and positions the workpiece by holding the workpiece in a predetermined direction on the basis of the detected position and direction of the workpiece.

### SUMMARY OF THE INVENTION

According to a first aspect of the present disclosure, a robot system includes a robot capable of holding a workpiece, a plurality of support portions capable of supporting the workpiece in respective orientations different from each other, and a controller configured to control the robot. The controller is configured to be capable of executing first processing of causing the robot to hold the workpiece, and second processing of causing the robot to change a holding manner of the workpiece by using at least one support portion among the plurality of support portions.

According to a second aspect of the present disclosure, a stage includes a plurality of support portions capable of supporting a workpiece in respective orientations different from each other.

According to a third aspect of the present disclosure, a control method for a robot system including a robot capable of holding a workpiece, a plurality of support portions capable of supporting the workpiece in respective orientations different from each other, and a controller configured to control the robot includes executing first processing in which the controller causes the robot to hold the workpiece and second processing in which the controller causes the robot to change a holding manner of the workpiece by using at least one support portion among the plurality of support portions.

Further features of the present invention will become apparent from the following description of exemplary embodiments with reference to the attached drawings.

### BRIEF DESCRIPTION OF THE DRAWINGS

FIG. 1 is an explanatory diagram illustrating a schematic configuration of a robot system according to an embodiment.

FIG. 2A is an explanatory diagram of a supply stage and a conveyance mechanism according to the embodiment.

FIG. 2B is a block diagram illustrating a control apparatus according to the embodiment.

FIG. 3A is an explanatory diagram of a workpiece according to the embodiment.

FIG. 3B is an explanatory diagram of the workpiece according to the embodiment.

FIG. 3C is an explanatory diagram of the workpiece according to the embodiment.

FIG. 4A is an explanatory diagram of an example of a holding operation by a robot hand according to the embodiment.

FIG. 4B is an explanatory diagram of an example of the holding operation by the robot hand according to the embodiment.

FIG. 4C is an explanatory diagram of an example of the holding operation by the robot hand according to the embodiment.

FIG. 5 is an explanatory diagram of a conversion stage according to the embodiment.

FIG. 6A is a flowchart of a control method of a robot system according to the embodiment.

FIG. 6B is an explanatory diagram of the control method of the robot system according to the embodiment.

FIG. 7A is a flowchart of the control method of the robot system according to the embodiment.

FIG. 7B is an explanatory diagram of the control method of the robot system according to the embodiment.

FIG. 8A is a flowchart of the control method of the robot system according to the embodiment.

FIG. 8B is an explanatory diagram of the control method of the robot system according to the embodiment.

FIG. 9A is a flowchart of the control method of the robot system according to the embodiment.

FIG. 9B is an explanatory diagram of the control method of the robot system according to the embodiment.

FIG. 10 is an explanatory diagram of an assembly stage according to a modification example of the embodiment.

### DESCRIPTION OF THE EMBODIMENTS

Japanese Patent Application Laid-Open No. 2013-212580 and Japanese Patent Application Laid-Open No. H08-243961 both disclose that a robot changing the holding manner of a workpiece on a temporary placement stage, but the position and orientation of the workpiece placed on a box or the like varies, and the holding orientation of the workpiece held by the robot with respect to the robot also varies.

Therefore, since the workpiece that is to be held by a robot in various orientations is temporarily placed on the temporary placement stage, it can be difficult for the robot to perform the operation of changing the holding manner of the workpiece depending on the position and orientation of the workpiece temporarily placed on the temporarily placement stage, due to the restriction of the range in which the robot can operate.

The present disclosure provides a technique advantageous for causing the robot to change the holding manner of the workpiece.

An exemplary embodiment of the present disclosure will be described in detail below with reference to drawings. The embodiment described below is an exemplification of a preferable configuration of the present disclosure, and, for example, details thereof can be appropriately modified for implementation by one skilled in the art within the gist of the present disclosure. In addition, it is assumed that, in the drawings referred to in the description of the embodiment below, elements denoted by the same reference numerals have substantially the same function unless otherwise described. In addition, these drawings are schematically expressed for the sake of convenience of illustration and description, and therefore the shapes, sizes, and arrangements thereof are not necessarily strictly consistent throughout the drawings.

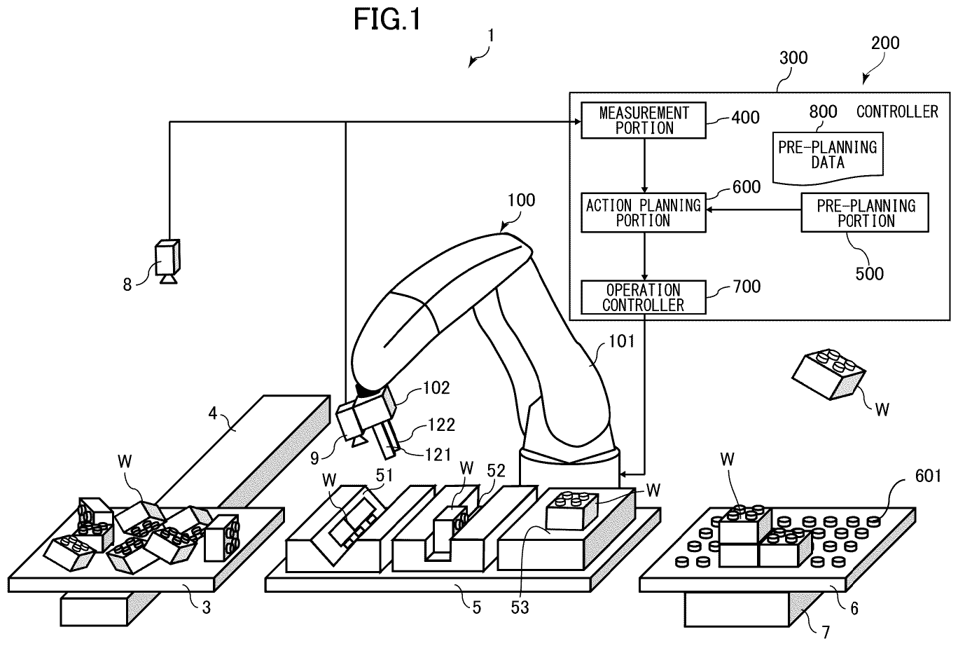

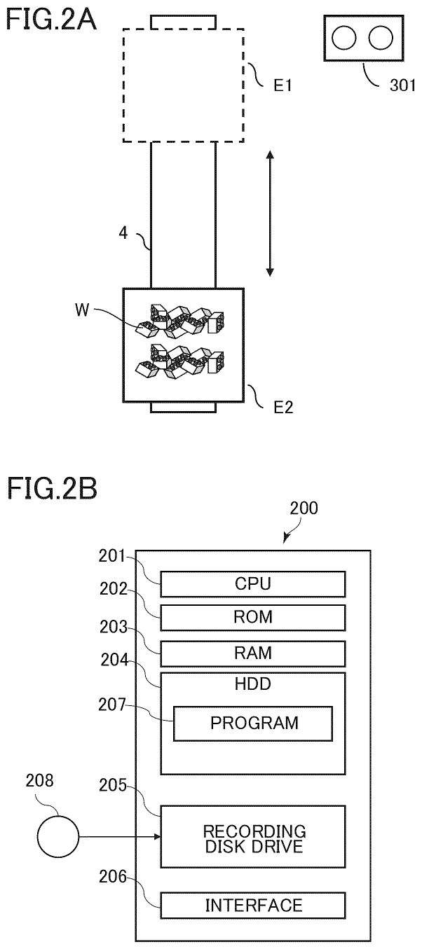

FIG. 1 is an explanatory diagram illustrating a schematic configuration of a robot system 1 according to the embodiment. The robot system 1 includes a supply stage 3, a conveyance mechanism 4, a conversion stage 5, an assembly stage 6, a lifting/lowering mechanism 7, a vision sensor 8, a vision sensor 9, a robot 100, and a control apparatus 200. FIG. 2A is an explanatory diagram of the supply stage 3 and the conveyance mechanism 4 according to the embodiment.

The robot 100 is an industrial robot, and is installed in a distribution line or a manufacture line. The robot 100 is a manipulator. The robot 100 is fixed to, for example, an unillustrated stand. The supply stage 3, the conversion stage 5, and the assembly stage 6 are disposed in a movable range of the robot 100.

The robot 100 and the control apparatus 200 are interconnected directly or through a network in a wired or wireless manner. The vision sensors 8 and 9 and the control apparatus 200 are interconnected directly or through a network in a wired or wireless manner. The conveyance mechanism 4 and the control apparatus 200 are interconnected directly or through a network in a wired or wireless manner. The lifting/lowering mechanism 7 and the control apparatus 200 are interconnected directly or through a network in a wired or wireless manner.

The supply stage 3 is an example of a placement portion on which one or more workpieces W are placed. The workpiece W can be supplied onto the supply stage 3 by a worker or an apparatus. In addition, the workpiece W can be removed from the upper surface of the supply stage 3 by the robot 100. In addition, a plurality of workpieces W can be randomly placed on the supply stage 3. To be noted, a box may be placed on the supply stage 3, and a plurality of workpieces may be charged into the box and thus randomly placed.

The conveyance mechanism 4 is configured such that the supply stage 3 can be conveyed between an area E1 in which the workpiece W is supplied to the supply stage 3 and an area E2 in which the supply stage 3 is within the field angle of the vision sensor 8. In the case where the conveyance mechanism 4 moves to the supply stage 3 to the area E1, the worker or an unillustrated supply apparatus can supply the workpiece W onto the supply stage 3.

A case where a worker supplies the workpiece W onto the supply stage 3 will be described as an example. A supply completion tool 301 is disposed in the vicinity of the area E1. The supply completion tool 301 includes, for example, a switch and a lamp. The supply completion tool 301 has a function of presenting the worker a timing at which the workpiece W can be supplied onto the supply stage 3 by using the lamp, and a function of notifying the control apparatus 200 of the completion of supply of the workpiece W by operation of the switch by the worker.

The control apparatus 200 receives the notification of supply completion from the supply completion tool 301, and then causes the conveyance mechanism 4 to move the supply stage 3 from the area E1 to the area E2. By causing the conveyance mechanism 4 to move the supply stage 3 from the area E1 to the area E2, the worker or the supply apparatus can perform the operation of supplying the workpiece W.

The conversion stage 5 is a stage (support stage) that supports the workpiece W that is temporarily placed thereon. The conversion stage 5 includes a plurality of support portions 51, 52, and 53. The workpiece W can be temporarily placed on each of the support portions 51, 52, and 53. To be noted, the workpiece W being temporarily placed means that the workpiece W is temporarily placed without being assembled or the like.

The lifting/lowering mechanism 7 is a mechanism that lifts and lowers the assembly stage 6 by control of the control apparatus 200. The assembly stage 6 includes a plurality of bosses 601 capable of positioning the workpiece W. An assembly work by the robot 100 can be performed on the assembly stage 6 in a state in which the lifting/lowering mechanism 7 has moved up. In the case where a product such as an intermediate product or a final product is completed, the lifting/lowering mechanism 7 can be moved down, and thus the product can be removed from the assembly stage 6 and conveyed by the robot 100.

The vision sensor 8 is an example of a sensor, and has a function of sensing the workpiece W placed on the supply stage 3 positioned in the area E2. That is, the vision sensor 8 is a sensor used for obtaining the information of the position and orientation of the workpiece W placed on the supply stage 3.

The vision sensor 9 has a function of sensing the workpiece W placed on a support portion 53 on the conversion stage 5 that will be described later. That is, the vision sensor 9 is a sensor used for obtaining the information of the position and orientation of the workpiece W placed on the support portion 53 on the conversion stage 5.

The vision sensor 8 is disposed at a position where the vision sensor 8 is capable of imaging the workpiece W placed on the supply stage 3 having moved to the area E2. For example, the vision sensor 8 is positioned above the supply stage 3 moving to the area E2. The vision sensor 8 is fixed to an unillustrated frame disposed around the robot 100.

The vision sensor 9 is disposed at a position where the vision sensor 9 can image the workpiece W disposed on the conversion stage 5. For example, the vision sensor 9 is disposed on the robot 100.

The vision sensors 8 and 9 each output a captured image serving as sensing data to the control apparatus 200 as a sensing result. The captured image is a gradation image, for example, a monochromatic image or a color image. The color image is, for example, an RGB image.

In the present embodiment, the vision sensors 8 and 9 are each a camera (digital camera) including an unillustrated image sensor. The image sensor is, for example, a complementary metal oxide semiconductor (CMOS) image sensor or a charge-coupled device (CCD) image sensor. The vision sensors 8 and 9 each image an object, and outputs the captured image in which the object is thus captured to the control apparatus 200 as the sensing data.

To be noted, the installation position of the vision sensor 8 is not limited to the robot 100 as long as the workpiece W supplied onto the supply stage 3 can be sensed. In addition, the vision sensor 8 may be a single-lens camera (two-dimensional camera), or a stereo camera (three-dimensional camera). In addition, the number of vision sensors 8 is not limited to one, and may be a plural number.

In addition, the installation position of the vision sensor 9 is not limited to the frame as long as the workpiece W placed on the conversion stage 5 can be sensed. In addition, the vision sensor 9 may be a single-lens camera (two-dimensional camera), or a stereo camera (three-dimensional camera). In addition, the number of vision sensors 9 is not limited to one, and may be a plural number.

The robot 100 is configured to be capable of holding the workpiece W. The robot 100 includes a robot arm 101, and a robot hand 102 serving as an example of an end effector. In the present embodiment, the robot 100 is configured to be capable of holding the workpiece W by the robot hand 102. The robot arm 101 is, for example, a vertically articulated robot arm. The root end of the robot 100 is a fixed end, and is fixed to an unillustrated stand. The distal end of the robot 100 is a free end. That is, as a result of operating the robot 100, the distal end of the robot 100 moves to an arbitrary position. To be noted, the robot arm 101 is not limited to a vertically articulated robot arm as long as the robot arm 101 has a degree of freedom required for causing the robot hand 102 to hold the workpiece W. For example, the robot arm 101 may be an orthogonal robot, a parallel link robot arm, or a selective compliance assembly robot arm (SCARA).

The robot hand 102 is supported by the robot arm 101. The robot hand 102 is attached to a predetermined portion of the robot arm 101, for example, the distal end of the robot arm 101. The robot hand 102 is configured to be capable of holding each of the workpieces W that are randomly disposed on the supply stage 3.

The robot hand 102 includes at least two finger portions, which are two finger portions 121 and 122 in the present embodiment. To be noted, the number of the finger portions included in the robot hand 102 is not limited to two, and may be three or more.

According to the configuration of the robot 100 described above, the robot hand 102 can be moved to a desired position by the robot arm 101, and the robot 100 can be caused to perform a work of holding the workpiece W.

To be noted, the robot 100 can, in a manufacture line for manufacturing a product, hold the workpiece by the robot hand 102 to perform a conveyance work or an assembly work of coupling the workpiece to another workpiece, or grip a tool to perform a processing work on the workpiece. Alternatively, the robot 100 can perform a work by attaching an actuator different from the robot hand 102 to the distal end of the robot arm 101 instead of the robot hand 102 in accordance with the details of the work in a manufacturing process.

For example, a plurality of workpieces W are disposed on the supply stage 3. A product that is an assembled product can be manufactured by a manufacturing method of causing the robot 100 to hold one workpiece W on the supply stage 3 and couple the workpiece W to another workpiece. The assembled product may be an intermediate product or a final product.

The control apparatus 200 is configured to control the robot 100, the conveyance mechanism 4, and the like. In the present embodiment, in accordance with the control by the control apparatus 200, the robot 100 performs an assembly work in which the robot 100 holds one workpiece W among the plurality of workpieces W randomly disposed on the supply stage 3, executes a holding switching operation of the workpiece W on the conversion stage 5 once or more times if necessary, conveys the workpiece W such that the workpiece W is in a designated position and orientation, and performs an assembly work of assembling the product on the assembly stage 6.

In the present embodiment, the control apparatus 200 is constituted by a computer. The control apparatus 200 can cause the vision sensors 8 and 9 to capture an image by transmitting an imaging command to the vision sensors 8 and 9. The control apparatus 200 is configured to be capable of obtaining image information (image data) generated by the vision sensors 8 and 9, and is configured to be capable of processing the obtained image information. In addition, the control apparatus 200 is capable of performing control processing for controlling the robot 100 in addition to information processing.

FIG. 2B is a block diagram of the control apparatus 200 according to the embodiment. The control apparatus 200 is constituted by a computer, and includes a central processing unit (CPU) 201 serving as an example of a processor. In addition, the control apparatus 200 includes, as storage portions, a read-only memory (ROM) 202, a random access memory: (RAM) 203, and a hard disk drive (HDD) 204. In addition, the control apparatus 200 includes a recording disk drive 205, and an interface 206 that is an input/output interface.

The CPU 201, the ROM 202, the RAM 203, the HDD 204, the recording disk drive 205, and the interface 206 are interconnected via a bus such that data can be communicated therebetween. The ROM 202 stores a basic program related to the operation of the computer. The RAM 203 is a storage device that temporarily stores various data such as results of arithmetic processing by the CPU 201. The HDD 204 stores results of arithmetic processing by the CPU 201, various data obtained from the outside, and the like, and also stores a program 207 to be executed by the CPU 201. The program 207 is application software for causing the CPU 201 to function as a controller 300 of FIG. 1. Therefore, the CPU 201 is capable of functioning as the controller 300 and performing various control processing of a control method by executing the program 207.

The recording disk drive 205 is capable of loading various data, programs and the like stored in a recording disk 208. To be noted, although the HDD 204 serves as a non-transitory computer-readable recording medium and the program 207 is stored in the HDD 204 in the present embodiment, the configuration is not limited to this. The program 207 may be stored in any recording medium as long as the program 207 is stored in a non-transitory computer-readable recording medium. As the recording medium for supplying the program 207 to the computer, for example, flexible disks, hard disks, optical disks, magneto-photo disks, magnetic tapes, nonvolatile memories, and the like can be used.

In addition, the control apparatus 200 may be configured to be capable of communicating with an external device through a network, and the program 207 may be downloaded from the external device through the network.

In addition, although the CPU 201 of the control apparatus 200 is configured to execute the processing of the controller 300, the configuration is not limited to this. For example, the control processing of the controller 300 may be executed by a combination of a plurality of CPUs.

As illustrated in FIG. 1, the controller 300 includes a measurement portion 400, a pre-planning portion 500, pre-planning data 800, an action planning portion 600, and an operation controller 700.

The measurement portion 400 has a function of measuring the position and orientation of each workpiece W on the supply stage 3 on the basis of a captured image obtained from the vision sensor 8. In addition, the measurement portion 400 has a function of measuring the position and orientation of the workpiece W on the conversion stage 5 on the basis of a captured image obtained from the vision sensor 9.

The pre-planning portion 500 has a function of generating the pre-planning data 800 required for causing the robot 100 to perform an orientation conversion operation. The action planning portion 600 has a function of generating a plan of actions (operations) of the robot 100 for changing the position and orientation of the workpiece W on the basis of the information (measurement data) of the position and orientation of the workpiece W obtained from the measurement portion 400 and the pre-planning data 800. The operation controller 700 has a function of controlling the robot 100 on the basis of the plan of actions of the robot 100, and a function of controlling the conveyance mechanism 4.

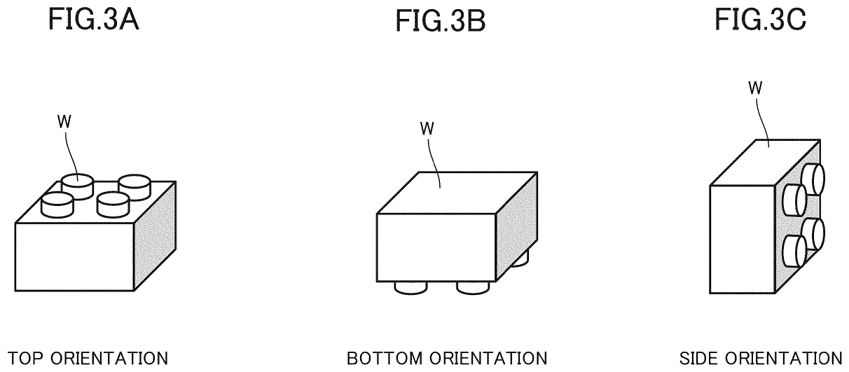

FIGS. 3A to 3C are explanatory diagrams of the workpiece W according to the embodiment. The workpiece W is a block having an approximate hexahedron shape, and each orientation in which a surface thereof is in contact with a flat surface is a stable orientation. The workpiece W has a top surface including a plurality of bosses, a bottom surface in which a plurality of bosses can fit, and four side surfaces.

In the description below, the orientation of the workpiece W in which the top surface of the workpiece W faces upward as illustrated in FIG. 3A will be referred to as a top orientation, the orientation of the workpiece W in which the bottom surface of the workpiece W faces upward as illustrated in FIG. 3B will be referred to as a bottom orientation, and the orientation of the workpiece W in which one of the four side surfaces of the workpiece W faces upward as illustrated in FIG. 3C will be referred to as a side orientation.

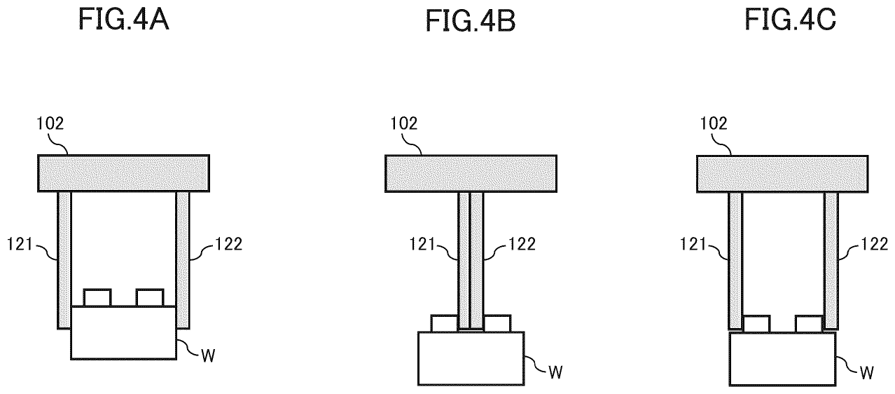

The holding operation by the robot hand 102 will be described. FIGS. 4A to 4C are explanatory diagrams of an example of the holding operation by the robot hand 102 according to the embodiment. The robot hand 102 is capable of holding a plurality of portions of the workpiece W. The robot hand 102 can pick up one of the plurality of workpieces W randomly disposed on the supply stage 3 and hold the workpiece W in various orientations as illustrated in FIGS. 4A to 4C. Therefore, the holding operation of the workpiece W is successful at a high possibility by using the robot hand 102.

FIG. 4A illustrates a state in which the workpiece W is gripped on the two side surfaces thereof by the robot hand 102 in the top orientation with respect to the robot hand 102. FIG. 4B illustrates a state in which the workpiece W is gripped on the inside of two bosses on the top surface of the workpiece W by the robot hand 102 in the top orientation with respect to the robot hand 102. FIG. 4C illustrates a state in which the workpiece W is gripped on the outside of two bosses on the top surface of the workpiece W by the robot hand 102 in the top orientation with respect to the robot hand 102.

To be noted, the holding orientation of the workpiece W by the robot hand 102 is not limited to the orientations exemplified in FIGS. 4A to 4C.

The robot hand 102 includes an unillustrated motor that drives opening and closing of the two finger portions 121 and 122, and an unillustrated current sensor that detects the current supplied to the motor. The operation controller 700 determines whether or not the holding of the workpiece W by the robot hand 102 is successful on the basis of the current value of the current detected by the current sensor. As a result of this, the operation controller 700 can retry the holding operation in the case where the holding operation of the workpiece W by the robot hand 102 is unsuccessful.

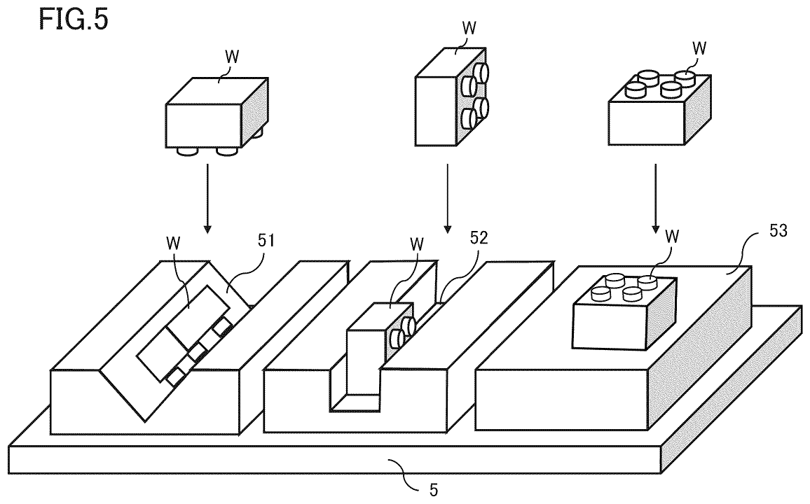

FIG. 5 is an explanatory diagram of the conversion stage 5 according to the embodiment. The conversion stage 5 includes a plurality of support portions, for example, three support portions 51, 52, and 53. The support portions 51, 52, and 53 are configured to be capable of supporting the workpiece W in respective stable orientations different from each other. In the present embodiment, the support portions 51, 52, and 53 each have a different shape. Further, the support portions 51, 52, and 53 each have a shape in which the workpiece W is oriented in a stable orientation by the weight thereof when the workpiece W is placed thereon.

The support portion 51 is a surface having a V-shaped cross-section that can support the workpiece W in a stable orientation which is an oblique orientation in which the top surface of the workpiece W and one of the four side surfaces of the workpiece W are in contact with the support portion 51 and the bottom surface of the workpiece W and another of the four side surfaces of the workpiece W face upward. The support portion 52 is a surface having a U-shaped cross-section that can support the workpiece W in a stable orientation that is the side orientation. The support portion 53 is a flat surface that can support the workpiece W in a stable orientation that is the top orientation.

When the workpiece W is temporarily placed on the support portion 51, 52, or 53, the workpiece W is pulled into the stable orientation by the weight of the workpiece W in accordance with the shape of the support portion 51, 52, or 53 on the support portion 51, 52, or 53, and thus the workpiece W is supported in the stable orientation on the support portion 51, 52, or 53.

Here, in the present embodiment, the robot 100 can convey the workpiece W from the support portion 51 to the support portion 52 such that the workpiece W supported in a stable orientation on the support portion 51 is supported in the side orientation on the support portion 52. However, due to the restriction of the movable range, the robot 100 cannot convey the workpiece W from the support portion 51 to the support portion 53 directly such that the workpiece W supported in the stable orientation on the support portion 51 is supported in the top orientation on the support portion 53. In contrast, the robot 100 can convey the workpiece W from the support portion 52 to the support portion 53 such that the workpiece W supported in the stable orientation on the support portion 52 is supported in the top orientation on the support portion 53.

Therefore, in the present embodiment, one of four trajectories is generated as an operation plan. The four trajectories include a trajectory in which the workpiece W is directly conveyed from the supply stage 3 to the assembly stage 6, a trajectory in which the workpiece W is conveyed from the supply stage 3 to the assembly stage 6 via the support portion 53, a trajectory in which the workpiece W is conveyed from the supply stage 3 to the assembly stage 6 via the support portions 52 and 53 in this order, and a trajectory in which the workpiece W is conveyed from the supply stage 3 to the assembly stage 6 via the support portions 51, 52, and 53 in this order.

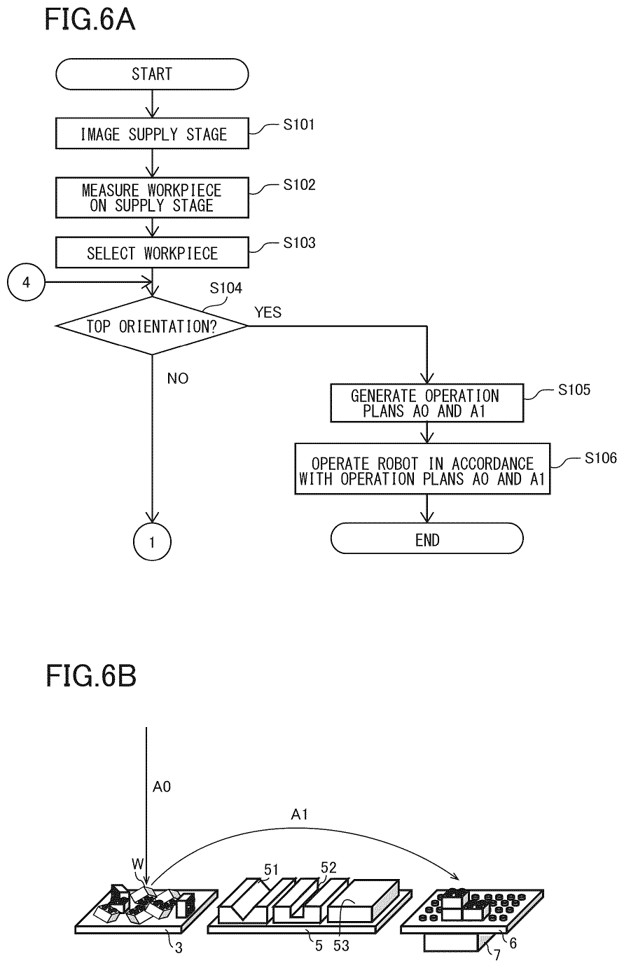

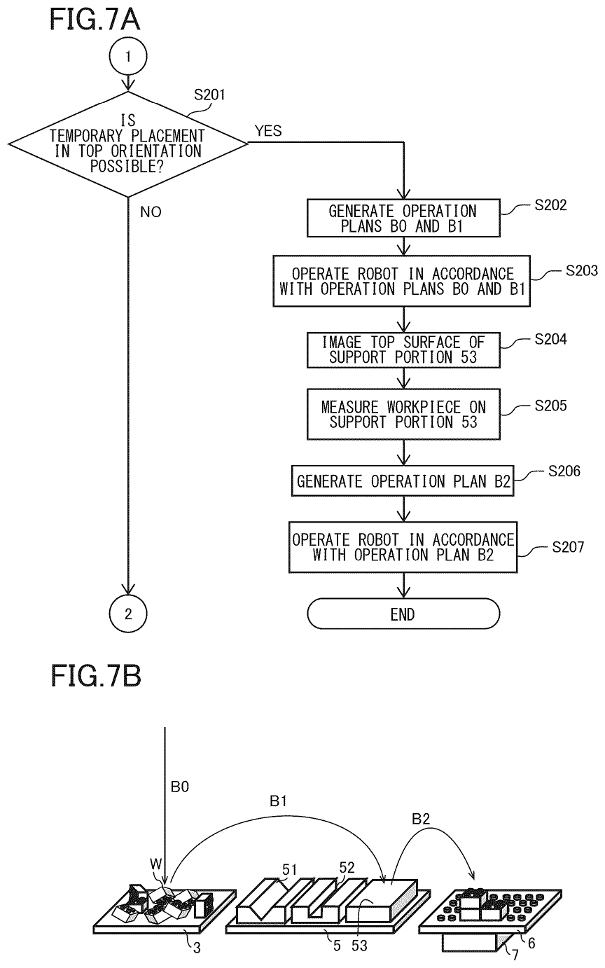

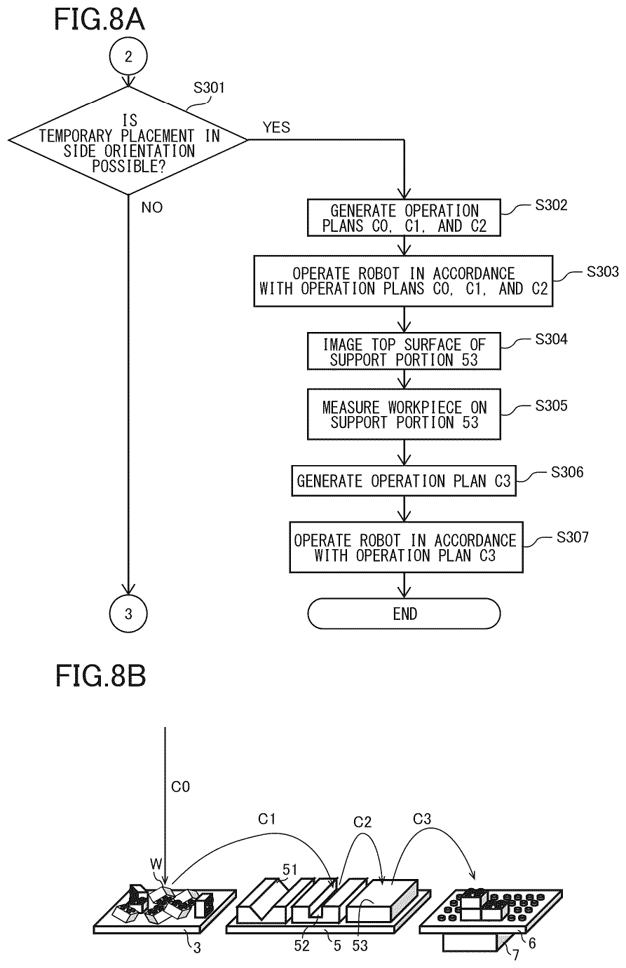

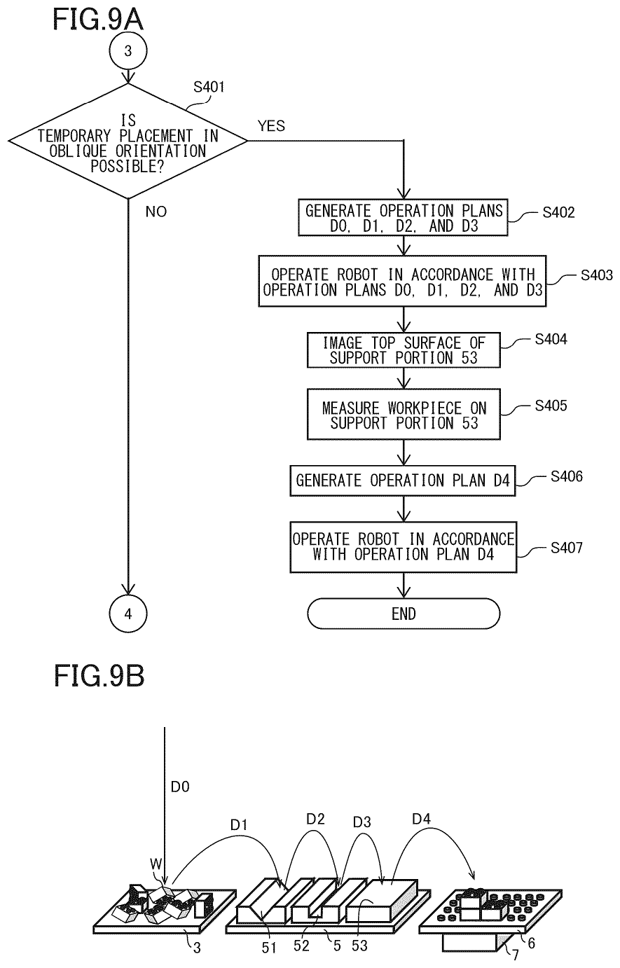

A control method for the robot system 1 will be described in detail below. FIGS. 6A, 7A, 8A, and 9A are flowcharts of the control method for the robot system 1 according to the embodiment. FIGS. 6B, 7B, 8B, and 9B are explanatory diagrams of the control method for the robot system 1 according to the embodiment.

To be noted, the operation controller 700 causes the conveyance mechanism 4 to move the supply stage 3, onto which workpieces W have been supplied, from the area El to the area E2 in advance. In addition, the pre-planning portion 500 calculates orientation data of the workpiece W with respect to the robot hand 102 capable of temporarily placing the workpiece W on the support portions 51, 52, and 53 in advance, and sets the calculated orientation data as the pre-planning data 800.

In step S101, the measurement portion 400 causes the vision sensor 8 to image the workpiece W on the supply stage 3, and obtains the captured image from the vision sensor 8.

In step S102, the measurement portion 400 measures the position and orientation of the workpiece W on the supply stage 3 on the basis of the captured image serving as an example of a sensing result obtained from the vision sensor 8, and thus obtains the information of the position and orientation of the workpiece W on the supply stage 3.

In addition, the measurement portion 400 also measures the number of workpieces W on the supply stage 3. In the case where the measurement result by the measurement portion 400 indicates that there is no longer any workpiece W on the supply stage 3, the operation controller 700 causes the conveyance mechanism 4 to move the supply stage 3 from the area E2 to the area E1. As a result of this, no additional sensor other than the vision sensor 8 needs to be provided to detect the number of workpieces W on the supply stage 3.

Next, in step S103, the action planning portion 600 selects one of the one or more workpieces W on the supply stage 3 as a holding target. For example, the action planning portion 600 obtains a priority indicating the holdability of the workpiece W for each of the plurality of workpieces W, and selects the workpiece W with the highest priority. The selected workpiece W will be described below.

In step S104, the action planning portion 600 determines whether or not the workpiece W on the supply stage 3 is in such a position and orientation that the robot 100 can hold the workpiece W in the top orientation.

In the case where the robot 100 can hold the workpiece W in the top orientation, that is, in the case where the result of step S104 is YES, the action planning portion 600 generates operation plans A0 and A1 in step S105.

The operation plan A0 is an operation plan in which the robot 100 is caused to hold the workpiece W on the supply stage 3. The operation plan A1 is an operation plan in which the workpiece W held by the robot 100 is conveyed from the supply stage 3 to the assembly stage 6. The operation plans A0 and A1 include trajectory data of the robot arm 101.

In step S106, the operation controller 700 controls the operation of the robot 100 in accordance with the operation plan A0, and causes the robot hand 102 of the robot 100 to hold the workpiece W placed on the supply stage 3. That is, the operation controller 700 controls the robot 100 in accordance with the operation plan A0 corresponding to the position and orientation of the workpiece W measured by the measurement portion 400, and thus performs the holding operation of causing the robot hand 102 to hold the workpiece W. As described above, the operation controller 700 can perform the processing (first processing) of causing the robot 100 to hold the workpiece W in accordance with the operation plan A0.

Next, the operation controller 700 controls the operation of the robot 100 in accordance with the operation plan A1, and thus causes the robot 100 to directly convey the workpiece W from the supply stage 3 to the assembly stage 6 (third processing). That is, since the orientation of the workpiece W held by the robot 100 is a predetermined orientation (top orientation), the operation controller 700 does not perform processing (second processing) of causing the robot 100 to change the holding manner of the workpiece W by using the conversion stage 5 described later. Further, the operation controller 700 performs, as the third processing, an assembly work of coupling the workpiece W to the assembly stage 6 or another workpiece on the assembly stage 6 in the top orientation.

In the case where the robot 100 cannot hold the workpiece W in the top orientation, that is, in the case where the result of step S104 is NO, the action planning portion 600 checks whether or not the workpiece W on the supply stage 3 is in such a position and orientation that the workpiece W can be temporarily placed in the top orientation on the basis of the pre-planning data 800 in step S201.

In the case where the workpiece on the supply stage 3 is in such a position and orientation that the workpiece W can be temporarily placed in the top orientation, that is, in the case where the result of step S201 is YES, the action planning portion 600 generates operation plans B0 and B1 in step S202.

The operation plan B0 is an operation plan in which the robot 100 is caused to hold the workpiece W on the supply stage 3. The operation plan B1 is an operation plan in which the workpiece W held by the robot 100 is conveyed from the supply stage 3 to the support portion 53. The operation plans B0 and B1 include the trajectory data of the robot arm 101.

That is, the action planning portion 600 selects at least one support portion from the plurality of support portions 51, 52, and 53 on the basis of the position and orientation of the workpiece W on the supply stage 3. In step S202, the action planning portion 600 selects the support portion 53. Then, the action planning portion 600 plans the operation of the robot B0 and B1.

In step S203, the operation controller 700 controls the operation of the robot 100 in accordance with the operation plan B0, and thus causes the robot hand 102 of the robot 100 to hold the workpiece W placed on the supply stage 3. That is, the operation controller 700 controls the robot 100 in accordance with the operation plan BO corresponding to the position and orientation of the workpiece W measured by the measurement portion 400, and thus performs the holding operation of causing the robot hand 102 to hold the workpiece W. As described above, the operation controller 700 can perform the processing (first processing) of causing the robot 100 to hold the workpiece W in accordance with the operation plan BO.

Next, the operation controller 700 controls the operation of the robot 100 in accordance with the operation plan B1, and causes the robot 100 to convey the workpiece W from the supply stage 3 to the support portion 53. The robot 100 releases the workpiece W on the support portion 53, and thus temporarily places the workpiece W on the support portion 53 in the top orientation.

After the temporary placement of the workpiece W in the top orientation on the support portion 53 is completed, in step S204, the operation controller 700 temporarily controls the robot arm 101 to position the robot hand 102, that is, the vision sensor 9 to a predetermined position above the support portion 53. Then, the measurement portion 400 causes the vision sensor 9 to image the workpiece W temporarily placed on the support portion 53, and obtains a captured image from the vision sensor 9.

Then, in step S205, the measurement portion 400 measures the position and orientation of the workpiece W on the support portion 53 on the basis of the captured image obtained from the vision sensor 9.

Next, in step S206, the action planning portion 600 generates an operation plan B2. The operation plan B2 is an operation plan in which the orientation of the robot 100 is changed, the workpiece W placed on the support portion 53 is held by the robot 100 again, and the workpiece W is conveyed onto the assembly stage 6. The operation plan B2 includes trajectory data of the robot arm 101.

Next, in step S207, the operation controller 700 controls the operation of the robot 100 in accordance with the operation plan B2, causes the robot 100 to hold the workpiece W on the support portion 53, and causes the robot 100 to convey the workpiece W from the support portion 53 to the assembly stage 6.

That is, the operation controller 700 causes the robot 100 to change the holding manner of the workpiece W such that the orientation of the workpiece W with respect to the robot 100 is a predetermined orientation (top orientation). As a result of this, the operation controller 700 performs an assembly work of coupling the workpiece W to the assembly stage 6 or another workpiece on the assembly stage 6 in the top orientation.

As described above, the operation controller 700 can perform processing (second processing) of causing the robot 100 to change the holding manner of the workpiece W by using at least one of the plurality of support portions 51, 52, and 53, for example the support portion 53. That is, the operation controller 700 causes the robot 100 to change the holding manner of the workpiece W by using the support portion 53 in the second processing, and thus performs a conversion operation of changing the orientation of the workpiece W with respect to the robot 100.

In the second processing, in the case of causing the robot 100 to change the holding manner of the workpiece W by using the support portion 53, the operation controller 700 causes the robot 100 to release the workpiece W to cause the support portion 53 to support the workpiece W, changes the posture of the robot 100, and causes the robot 100 to hold the workpiece W supported on the support portion 53 again.

In the case where the workpiece W on the supply stage 3 is in such a position and orientation that the workpiece W cannot be temporarily placed in the top orientation, that is, in the case where the result of step S201 is NO, in step S301, the action planning portion 600 checks whether or not the workpiece W on the supply stage 3 is in such a position and orientation that the workpiece W can be temporarily placed in the side orientation on the basis of the pre-planning data 800.

In the case where the workpiece W on the supply stage 3 is in such a position and orientation that the workpiece W can be temporarily placed in the side orientation, that is, in the case where the result of step S301 is YES, the action planning portion 600 generates operation plans C0, C1, and C2 in step S302.

The operation plan C0 is an operation plan in which the robot 100 is caused to hold the workpiece W on the supply stage 3. The operation plan C1 is an operation plan in which the workpiece W held by the robot 100 is conveyed from the supply stage 3 to the support portion 52.

The operation plan C2 is an operation plan in which the workpiece W held by the robot 100 again is conveyed from the support portion 52 to the support portion 53. The operation plans C0, C1, and C2 include the trajectory data of the robot arm 101.

That is, the action planning portion 600 selects at least one support portion from the plurality of support portions 51, 52, and 53 on the basis of the position and orientation of the workpiece W on the supply stage 3. In step S302, the action planning portion 600 selects the support portions 52 and 53. Then, the action planning portion 600 plans the operation of the robot 100 temporarily placing the workpiece W on the support portions 52 and 53 on the basis of the position and orientation of the workpiece W on the supply stage 3, and thus obtains the operation plans C0, C1, and C2.

In step S302, since the support portions 52 and 53 serving as two or more support portions are selected, the action planning portion 600 causes the robot 100 to change the holding manner of the workpiece W on each of the support portions 52 and 53 in a predetermined order, that is, the in the order of the support portion 52 and then the support portion 53.

In step S303, the operation controller 700 controls the operation of the robot 100 in accordance with the operation plan C0, and thus causes the robot hand 102 of the robot 100 to hold the workpiece W placed on the supply stage 3. That is, the operation controller 700 controls the robot 100 in accordance with the operation plan C0 corresponding to the position and orientation of the workpiece W measured by the measurement portion 400, and thus performs the holding operation of causing the robot hand 102 to hold the workpiece W. As described above, the operation controller 700 can perform the processing (first processing) of causing the robot 100 to hold the workpiece W in accordance with the operation plan C0.

Next, the operation controller 700 controls the operation of the robot 100 in accordance with the operation plan C1, and causes the robot 100 to convey the workpiece W from the supply stage 3 to the support portion 52. The robot 100 releases the workpiece W on the support portion 52, and temporarily places the workpiece W on the support portion 52 in the side orientation.

As described above, the robot 100 is capable of holding the workpiece W again, which has been temporarily placed on the support portion 52 in the side orientation, from another direction by changing the posture of the robot 100, and then temporarily placing the workpiece W in the top orientation on the support portion 53. Therefore, the operation controller 700 controls the operation of the robot 100 in accordance with the operation plan C2, and thus causes the robot hand 102 of the robot 100 to hold the workpiece W. Then, the operation controller 700 controls the operation of the robot 100 in accordance with the operation plan C2, and thus causes the robot 100 to convey the workpiece W from the support portion 52 to the support portion 53. The robot 100 releases the workpiece W on the support portion 53, and thus temporarily places the workpiece W in the top orientation on the support portion 53.

After the temporary placement of the workpiece W in the top orientation on the support portion 53 is completed, in step S304, the operation controller 700 temporarily controls the robot arm 101 to position the robot hand 102, that is, the vision sensor 9 to a predetermined position above the support portion 53. Then, the measurement portion 400 causes the vision sensor 9 to image the workpiece W temporarily placed on the support portion 53, and obtains a captured image from the vision sensor 9.

Then, in step S305, the measurement portion 400 measures the position and orientation of the workpiece W on the support portion 53 on the basis of the captured image obtained from the vision sensor 9.

Next, in step S306, the action planning portion 600 generates an operation plan C3. The operation plan C3 is an operation plan in which the posture of the robot 100 is changed, the workpiece W placed on the support portion 53 is held by the robot 100 again, and the workpiece W is conveyed onto the assembly stage 6. The operation plan C3 includes trajectory data of the robot arm 101.

Next, in step S307, the operation controller 700 controls the operation of the robot 100 in accordance with the operation plan C3, causes the robot 100 to hold the workpiece W on the support portion 53, and causes the robot 100 to convey the workpiece W from the support portion 53 to the assembly stage 6.

That is, the operation controller 700 causes the robot 100 to change the holding manner of the workpiece W such that the orientation of the workpiece W with respect to the robot 100 is a predetermined orientation (top orientation). As a result of this, the operation controller 700 performs an assembly work of coupling the workpiece W to the assembly stage 6 or another workpiece on the assembly stage 6 in the top orientation.

As described above, the operation controller 700 can perform processing (second processing) of causing the robot 100 to change the holding manner of the workpiece W by using at least one of the plurality of support portions 51, 52, and 53, for example the support portions 52 and 53. That is, the operation controller 700 causes the robot 100 to change the holding manner of the workpiece W by using the support portions 52 and 53 in the second processing, and thus performs the conversion operation of changing the orientation of the workpiece W with respect to the robot 100.

In the second processing, in the case of causing the robot 100 to change the holding manner of the workpiece W by using the support portion 52, the operation controller 700 causes the robot 100 to release the workpiece W to cause the support portion 52 to support the workpiece W, changes the posture of the robot 100, and causes the robot 100 to hold the workpiece W supported on the support portion 52 again.

In addition, in the second processing, in the case of causing the robot 100 to change the holding manner of the workpiece W by using the support portion 53, the operation controller 700 causes the robot 100 to release the workpiece W to cause the support portion 53 to support the workpiece W, changes the posture of the robot 100, and causes the robot 100 to hold the workpiece W supported on the support portion 53 again.

In addition, the support portion 53 is an example of a predetermined support portion configured to support the workpiece W in such an orientation that the workpiece W can be held by the robot 100 such that the orientation of the held workpiece W with respect to the robot 100 is a predetermined orientation (top orientation). In the second processing, the operation controller 700 causes the robot 100 to change the holding manner of the workpiece W lastly on the support portion 53 among the support portions 52 and 53. Then, the operation controller 700 causes the robot 100 to move the workpiece held by the robot 100 in the top orientation with respect to the robot 100, and thus causes the robot 100 to couple the workpiece W to another workpiece W.

In the case where the workpiece W on the supply stage 3 is in such a position and orientation that the workpiece W cannot be temporarily placed in the side orientation, that is, in the case where the result of step S301 is NO, in step S401, the action planning portion 600 checks whether or not the workpiece W on the supply stage 3 is in such a position and orientation that the workpiece W can be temporarily placed in the oblique orientation in which the bottom surface of the workpiece W on the supply stage 3 faces upward on the basis of the pre-planning data 800.

In the case where the workpiece W on the supply stage 3 is in such a position and orientation that the workpiece W can be temporarily placed in the oblique orientation, that is, in the case where the result of step S401 is YES, the action planning portion 600 generates operation plans D0, D1, D2, and D3 in step S402.

The operation plan D0 is an operation plan in which the robot 100 is caused to hold the workpiece W on the supply stage 3. The operation plan D1 is an operation plan in which the workpiece W held by the robot 100 is conveyed from the supply stage 3 to the support portion 51. The operation plan D2 is an operation plan in which the workpiece W held by the robot 100 again is conveyed from the support portion 51 to the support portion 52. The operation plan D3 is an operation plan in which the workpiece W held by the robot 100 again is conveyed from the support portion 52 to the support portion 53. The operation plans D0, D1, D2, and D3 include the trajectory data of the robot arm 101.

That is, the action planning portion 600 selects at least one support portion from the plurality of support portions 51, 52, and 53 on the basis of the position and orientation of the workpiece W on the supply stage 3. In step S402, the action planning portion 600 selects the support portions 51, 52, and 53. Then, the action planning portion 600 plans the operation of the robot 100 temporarily placing the workpiece W on the support portions 51, 52, and 53 on the basis of the position and orientation of the workpiece W on the supply stage 3, and thus obtains operation plans D0, D1, D2, D3, and D4.

In step S402, since the support portions 51, 52, and 53 serving as two or more support portions are selected, the action planning portion 600 causes the robot 100 to change the holding manner of the workpiece W on each of the support portions 51, 52, and 53 in a predetermined order, that is, the in the order of the support portions 51, 52 and 53.

In step S403, the operation controller 700 controls the operation of the robot 100 in accordance with the operation plan D0, and thus causes the robot hand 102 of the robot 100 to hold the workpiece W placed on the supply stage 3. That is, the operation controller 700 controls the robot 100 in accordance with the operation plan D0 corresponding to the position and orientation of the workpiece W measured by the measurement portion 400, and thus performs the holding operation of causing the robot hand 102 to hold the workpiece W. As described above, the operation controller 700 can perform the processing (first processing) of causing the robot 100 to hold the workpiece W in accordance with the operation plan D0.

Next, the operation controller 700 controls the operation of the robot 100 in accordance with the operation plan D1, and causes the robot 100 to convey the workpiece W from the supply stage 3 to the support portion 51. The robot 100 releases the workpiece W on the support portion 51, and temporarily places the workpiece W on the support portion 51 in the oblique orientation.

As described above, the robot 100 is capable of holding the workpiece W again, which has been temporarily placed on the support portion 51 in the oblique orientation, from another direction by changing the posture of the robot 100, and then temporarily placing the workpiece W in the side orientation on the support portion 52. Therefore, the operation controller 700 controls the operation of the robot 100 in accordance with the operation plan D2, and thus causes the robot hand 102 of the robot 100 to hold the workpiece W. Then, the operation controller 700 controls the operation of the robot 100 in accordance with the operation plan D2, and thus causes the robot 100 to convey the workpiece W from the support portion 51 to the support portion 52. The robot 100 releases the workpiece W on the support portion 52, and thus temporarily places the workpiece W in the side orientation on the support portion 52.

In addition, as described above, the robot 100 is capable of holding the workpiece W again, which has been temporarily placed on the support portion 52 in the side orientation, from another direction by changing the posture of the robot 100, and then temporarily placing the workpiece W in the side orientation on the support portion 53. Therefore, the operation controller 700 controls the operation of the robot 100 in accordance with the operation plan D3, and thus causes the robot hand 102 of the robot 100 to hold the workpiece W. Then, the operation controller 700 controls the operation of the robot 100 in accordance with the operation plan D3, and thus causes the robot 100 to convey the workpiece W from the support portion 52 to the support portion 53. The robot 100 releases the workpiece W on the support portion 53, and thus temporarily places the workpiece W in the top orientation on the support portion 53.

After the temporary placement of the workpiece W in the top orientation on the support portion 53 is completed, in step S404, the operation controller 700 temporarily controls the robot arm 101 to position the robot hand 102, that is, the vision sensor 9 to a predetermined position above the support portion 53. Then, the measurement portion 400 causes the vision sensor 9 to image the workpiece W temporarily placed on the support portion 53, and obtains a captured image from the vision sensor 9.

Then, in step S405, the measurement portion 400 measures the position and orientation of the workpiece W on the support portion 53 on the basis of the captured image obtained from the vision sensor 9.

Next, in step S406, the action planning portion 600 generates an operation plan D4. The operation plan D4 is an operation plan in which the posture of the robot 100 is changed, the workpiece W placed on the support portion 53 is held by the robot 100 again, and the workpiece W is conveyed onto the assembly stage 6. The operation plan D4 includes trajectory data of the robot arm 101.

Next, in step S407, the operation controller 700 controls the operation of the robot 100 in accordance with the operation plan D4, causes the robot 100 to hold the workpiece W on the support portion 53, and causes the robot 100 to convey the workpiece W from the support portion 53 to the assembly stage 6.

That is, the operation controller 700 causes the robot 100 to change the holding manner of the workpiece W such that the orientation of the workpiece W with respect to the robot 100 is a predetermined orientation (top orientation). As a result of this, the operation controller 700 performs an assembly work of coupling the workpiece W to the assembly stage 6 or another workpiece on the assembly stage 6 in the top orientation.

As described above, the operation controller 700 can perform processing (second processing) of causing the robot 100 to change the holding manner of the workpiece W by using at least one of the plurality of support portions 51, 52, and 53, for example the support portions 51, 52, and 53. That is, the operation controller 700 causes the robot 100 to change the holding manner of the workpiece W by using the support portions 51, 52, and 53 in the second processing, and thus performs the conversion operation of changing the orientation of the workpiece W with respect to the robot 100.

In the second processing, in the case of causing the robot 100 to change the holding manner of the workpiece W by using the support portion 51, the operation controller 700 causes the robot 100 to release the workpiece W to cause the support portion 51 to support the workpiece W, changes the posture of the robot 100, and causes the robot 100 to hold the workpiece W supported on the support portion 51 again.

In addition, in the second processing, in the case of causing the robot 100 to change the holding manner of the workpiece W by using the support portion 52, the operation controller 700 causes the robot 100 to release the workpiece W to cause the support portion 52 to support the workpiece W, changes the posture of the robot 100, and causes the robot 100 to hold the workpiece W supported on the support portion 52 again.

In addition, in the second processing, in the case of causing the robot 100 to change the holding manner of the workpiece W by using the support portion 53, the operation controller 700 causes the robot 100 to release the workpiece W to cause the support portion 53 to support the workpiece W, changes the posture of the robot 100, and causes the robot 100 to hold the workpiece W supported on the support portion 53 again.

In addition, the support portion 53 is an example of a predetermined support portion configured to support the workpiece W in such an orientation that the workpiece W can be held by the robot 100 such that the orientation of the held workpiece W with respect to the robot 100 is a predetermined orientation (top orientation). In the second processing, the operation controller 700 finally causes the robot 100 to change the holding manner of the workpiece W on the support portion 53 among the support portions 51, 52, and 53. Then, the operation controller 700 causes the robot 100 to move the workpiece W held by the robot 100 in the top orientation with respect to the robot 100, and thus causes the robot 100 to couple the workpiece W to another workpiece W.

According to the selection algorithm described above, the shortest-distance operation of the robot 100 from the supply stage 3 to the assembly stage 6 can be calculated in accordance with the position and orientation of the workpiece W on the supply stage 3.

As described above, the action planning portion 600 generates an action plan for changing the position and orientation of the workpiece W on the basis of the information (measurement data) of the position and orientation of the workpiece W obtained from the measurement portion 400. The operation controller 700 selects at least one support portion from the plurality of support portions 51 to 53 on the basis of the generated operation plan, and by using the selected at least one support portion, causes the robot 100 to change the holding manner of the workpiece W to change the orientation of the workpiece W with respect to the robot 100 to a predetermined orientation, and conveys the workpiece W to the assembly stage 6. The predetermined orientation is the top orientation serving as the final assembly orientation, and the conversion operation is performed on the conversion stage 5 until the orientation of the workpiece W with respect to the robot hand 102 of the robot 100 is the top orientation.

In addition, when coupling the workpiece W to another workpiece on the assembly stage 6, the workpiece W needs to be held by the robot hand 102 in a state in which the orientation of the workpiece W with respect to the robot hand 102 is highly precisely positioned to the top orientation.

In the present embodiment, the measurement portion 400 causes the vision sensor 9 to image the workpiece W temporarily placed on the support portion 53. The measurement portion 400 measures the position and orientation of the workpiece W on the support portion 53 on the basis of the captured image which has been obtained from the vision sensor 9 and in which the workpiece W on the support portion 53 is captured. The operation controller 700 controls the robot 100 to cause the robot hand 102 to hold the workpiece W in the top orientation. To be noted, in the case where the workpiece W on the supply stage 3 is in the top orientation, the orientation conversion operation is not performed.

The movable range of the robot 100 is limited. Therefore, if only one support portion is provided, the position and orientation of the workpiece W on the supply stage 3 that can be converted to the top orientation on the support portion is limited in a narrow range. Therefore, a situation in which there is no workpiece that can be converted to the top orientation on the supply stage 3 is more likely to occur, and a process of changing the position and orientation of the workpieces W by, for example, agitating the workpieces on the supply stage 3 needs to be performed. Therefore, the cycle time of the system can be longer.

In contrast, in the present embodiment, the plurality of support portions 51 to 53 required for changing the orientation of the workpiece W with respect to the robot hand 102 of the robot 100 are prepared. By using at least one of the support portions 51 to 53, a large number of workpieces W on the supply stage 3 can be each converted to the top orientation with respect to the robot hand 102 of the robot 100, and thus the cycle time of the robot system 1 can be made shorter, that is, the conveyance of the workpiece W from the supply stage 3 to the assembly stage 6 can be made faster.

In addition, since the workpiece W is supported in stable orientations different from each other and respectively corresponding to the support portions 51 to 53, the orientation of the workpiece W can be reliably changed on the conversion stage 5, and thus the conveyance of the workpiece W from the supply stage 3 to the assembly stage 6 can be made faster.

In addition, in the present embodiment, the action planning portion 600 selects a shortest-distance operation route from the supply stage 3 to the assembly stage 6 via at least one of the plurality of support portions 51 to 53 on the basis of the position and orientation of the workpiece W on the supply stage 3, and therefore quick operation of the robot 100 can be realized.

In addition, a plurality of workpieces W randomly arranged in various positions and orientations can be converted to a desired consistent orientation at high speed.

As described above, according to the present embodiment, a technique advantageous for the robot 100 to change the holding manner of the workpiece W is provided. Further, the controller 300 selects a required support portion from the plurality of support portions 51 to 53 in accordance with the position and orientation of the workpiece W on the supply stage 3 and uses the selected support portion for the orientation conversion of the workpiece W, thus the robot 100 can efficiently change the holding manner of the workpiece W, and therefore the cycle time can be shortened.

### First Modification Example of Embodiment

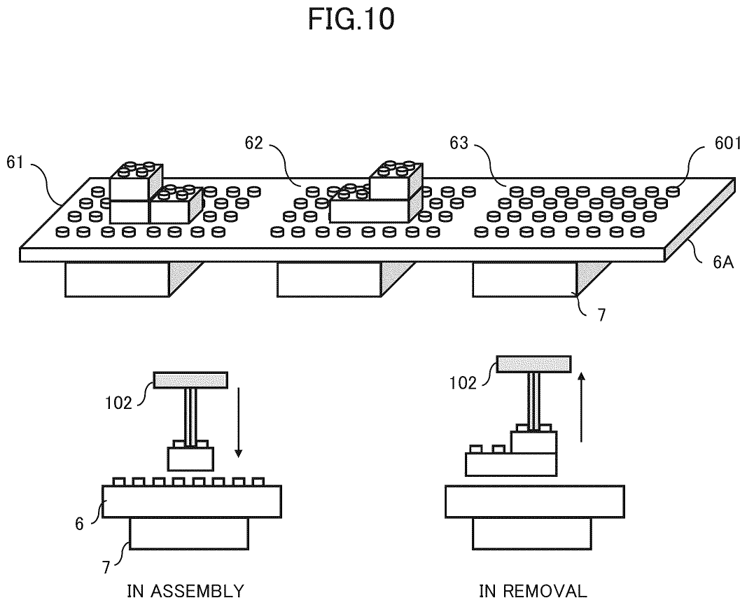

FIG. 10 is an explanatory diagram of an assembly stage 6A according to the first modification example of the embodiment. The assembly stage 6A has a larger area than the assembly stage 6, and includes a main assembly portion 61, a sub assembly portion 62, and a sub assembly portion 63.

When assembling the product on the main assembly portion 61, in the case where the point of effort and the point of action of the assembly force are offset from each other, there is a possibility that a moment is generated between the workpieces, and the assembly of the product fails.

The operation controller 700 assembles a sub assembly including two or more workpieces on the sub assembly portion 62 or the sub assembly portion 63 such that the point of effort and the point of action of the assembly force are not offset from each other, and then the assembly work is performed on the main assembly portion 61. As a result of this, the assembly work can be performed stably.

In addition, the assembly portions 61 to 63 each include bosses 601 capable of positioning the workpiece. The lifting/lowering mechanism 7 lifts and lowers the assembly stage 6A. The robot 100 can perform the assembly work in a state in which the lifting/lowering mechanism 7 has moved up. In the case where a sub assembly or the product is completed, the sub assembly or the product can be removed from the assembly portion 61, 62, or 63 by lowering the lifting/lowering mechanism 7, and thus the sub assembly or the product can be conveyed by the robot 100.

### Second Modification Example of Embodiment

Although a case where the conversion stage 5 includes the three support portions 51 to 53 as a plurality of support portions has been described in the embodiment described above, the configuration is not limited to this. The number of support portions included in the conversion stage 5 may be two, four, or more. It suffices as long as the plurality of support portions have shapes that can stably support the workpiece in orientations different from each other. In this case, it is preferable that the plurality of support portions have shapes different from each other.

The support portions each may be one of a plate having a flat surface, a mortar-shaped stage, a V-shaped stage, a stage having a cutout corresponding to the shape of the workpiece, a stage having a function of holding the workpiece by a chuck mechanism including a plurality of finger portions, a stage having a function of holding the workpiece by suction, and a stage having a function of adjusting the angle thereof by a rotary actuator.

In addition, each support portion may be designed to be optimized for each workpiece, and the frictional resistance may be lowered by using a material having high slidability to enhance the performance for pulling in the workpiece.

### Third Modification Example of Embodiment

Although a case where the conversion stage 5 includes a plurality of support portions has been described as an example in the embodiment described above, the configuration is not limited to this. For example, the robot system may include a plurality of conversion stages, and the plurality of conversion stages each may include one or more support portions.

As described above, according to the present disclosure, a technique advantageous for the robot to change the holding manner of the workpiece is provided.

### Other Modification Examples

The present disclosure is not limited to the embodiment described above, and the embodiment can be modified in many ways within the technical concept of the present disclosure. In addition, the effects described in the present embodiment are merely enumeration of the most preferable effects that can be obtained from the embodiment of the present disclosure, and the effect of the embodiment of the present disclosure is not limited to those described in the present embodiment.

Although a case where the robot arm is a vertically articulated robot arm has been described in the embodiment described above, the configuration is not limited to this. For example, the robot arm may be a horizontally articulated robot arm, a parallel link robot arm, or an orthogonal robot. In addition, the present disclosure is applicable to a machine that is capable of automatically performing extension, contraction, bending, vertical movement, horizontal movement, turning, or a composite operation of these on the basis of information in a storage device provided in the control apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-167520,filed Sep. 28, 2023, which is hereby incorporated by reference herein in its entirety.

What is claimed is:

1. A robot system comprising:
a robot capable of holding a workpiece;
a plurality of support portions capable of supporting the workpiece in respective orientations different from each other; and
a controller configured to control the robot,
wherein the controller is configured to be capable of executing:
first processing of causing the robot to hold the workpiece; and
second processing of causing the robot to change a holding manner of the workpiece by using at least one support portion among the plurality of support portions.

2. The robot system according to claim 1, wherein the controller is configured to, in the second processing, change an orientation of the workpiece with respect to the robot by causing the robot to change the holding manner of the workpiece by using the at least one support portion.

3. The robot system according to claim 1, wherein the controller is configured to, in a case of causing the robot to change the holding manner of the workpiece by using one support portion among the at least one support portion in the second processing, cause the robot to release the workpiece to cause the one support portion to support the workpiece, change a posture of the robot, and cause the robot to hold the workpiece supported by the one support portion again.

4. The robot system according to claim 1, wherein the plurality of support portions have shapes different from each other.

5. The robot system according to claim 1, wherein the plurality of support portions each have such a shape that that an orientation of the workpiece is determined by a weight of the workpiece.

6. The robot system according to claim 1, further comprising:
a placement portion on which the workpiece is placed;
wherein the controller is configured to, in the first processing, cause the robot to hold the workpiece placed on the placement portion.

7. The robot system according to claim 6, further comprising:
a sensor used for obtaining information of a position and orientation of the workpiece placed on the placement portion,
wherein the controller is configured to obtain the information of the position and orientation of the workpiece on a basis of a sensing result of the sensor.

8. The robot system according to claim 7,
wherein the sensor includes a camera, and
wherein the controller is configured to obtain the information of the position and orientation of the workpiece on a basis of a captured image obtained by the camera imaging the workpiece placed on the placement portion.

9. The robot system according to claim 7, wherein the controller is configured to select the at least one support portion from the plurality of support portions on a basis of the position and orientation of the workpiece.

10. The robot system according to claim 9, wherein the controller is configured to plan an operation of the robot to temporarily place the workpiece on the at least one support portion, on the basis of the position and orientation of the workpiece.

11. The robot system according to claim 10,
wherein the at least one support portion is two or more support portions, and
wherein the controller is configured to, in the second processing, cause the robot to change the holding manner of the workpiece by using each of the two or more support portions in a predetermined order.

12. The robot system according to claim 1, wherein the controller is configured to, in the second processing, cause the robot to change the holding manner of the workpiece such that an orientation of the workpiece with respect to the robot is changed to a predetermined orientation.

13. The robot system according to claim 12, wherein the controller is configured not to execute the second processing in a case where the orientation of the workpiece held by the robot in the first processing is the predetermined orientation.

14. The robot system according to claim 12, wherein one of the at least one support portion is configured to support the workpiece in such an orientation that the workpiece is capable of being held by the robot such that the orientation of the held workpiece with respect to the robot is the predetermined orientation.

15. The robot system according to claim 12,
wherein the at least one support portion is two or more support portions,
wherein one of the two or more support portions is a predetermined support portion configured to support the workpiece in such an orientation that the workpiece is capable of being held by the robot such that the orientation of the held workpiece with respect to the robot is the predetermined orientation, and
wherein the controller is configured to, in the second processing, cause the robot to change the holding manner of the workpiece by using the predetermined support portion lastly among the two or more support portions.

16. The robot system according to claim 15, wherein the predetermined support portion is a flat surface.

17. The robot system according to claim 12, wherein the controller is configured to, in the second processing, cause the robot to move the workpiece after causing the robot to hold the workpiece in a state in which the orientation of the workpiece with respect to the robot is the predetermined orientation.

18. The robot system according to claim 17, wherein the controller is configured to cause the robot to move the workpiece to couple the workpiece to another workpiece.

19. The robot system according to claim 1, wherein the plurality of support portions are capable of supporting the workpiece in respective predetermined orientations different from each other.

20. A stage comprising a plurality of support portions capable of supporting a workpiece in respective orientations different from each other.

21. A control method for a robot system including:
a robot capable of holding a workpiece;
a plurality of support portions capable of supporting the workpiece in respective orientations different from each other; and
a controller configured to control the robot, the control method comprising executing:
first processing in which the controller causes the robot to hold the workpiece; and
second processing in which the controller causes the robot to change a holding manner of the workpiece by using at least one support portion among the plurality of support portions.

22. A method for manufacturing a product, the method comprising manufacturing the product by using the robot system according to claim 1.

23. A non-transitory computer-readable recording medium storing a program for causing a computer to execute the control method according to claim 21.
